(19) United States
(12) Patent Application Publication
(10) Pub. No.: US 2024/0382889 A1
(43) Pub. Date: Nov. 21, 2024

(54) AIR PURIFYING DEVICE FOR PURIFYING AIR AND METHOD FOR OPERATING AN AIR PURIFYING DEVICE

(71) Applicant: AUDI AG, Ingolstadt (DE)

(72) Inventors: Matthew HALL, Marbach am Neckar (DE); Guido SCHIEDT, Leutenbach (DE); Alexander ZELLNER, Karlsruhe (DE)

(73) Assignee: AUDI AG, Ingolstadt (DE)

(21) Appl. No.: 18/692,566

(22) PCT Filed: Sep. 28, 2022
(86) PCT No.: PCT/EP2022/077022

§ 371 Date: Mar. 15, 2024

(30) Foreign Application Priority Data
Sep. 28, 2021 (DE) 10 2021 125 027.7

(51) Int. Cl. B01D 46/24; B01D 39/20; B01D 46/00; B01D 46/44; B01D 46/46; B01D 46/62; B01D 46/84

(52) U.S. Cl. CPC B01D 46/24; B01D 39/2093; B01D 46/0004; B01D 46/0028; B01D 46/0087; B01D 46/446; B01D 46/448; B01D 46/46; B01D 46/62; B01D 46/84; B01D 2239/0414; B01D 2239/0442; B01D 2279/65

(57) ABSTRACT

An air purifying device for purifying air, including a housing, on which an air inlet and an air outlet are formed, which are fluidically interconnected via a flow path extending in the housing. An air conveying device for conveying the air along the flow path and an air filter for filtering foreign particles out of the air are disposed in the flow path. The air filter has at least one filter body of a motor vehicle particle filter made of a ceramic material having a lipophilic surface.

### FIELD

The invention relates to an air purifying device for purifying air, comprising a housing, on which an air inlet and an air outlet are formed, which are fluidically interconnected via a flow path extending in the housing, wherein an air conveying device for conveying the air along the flow path and an air filter for filtering foreign particles out of the air are disposed in the flow path. The invention furthermore relates to a method for operating an air purifying device.

### BACKGROUND

DE 10 2018 008 259 A1, for example, is known from the prior art. This describes filter systems for suspended solids with particle sizes from 400 pm to less than or equal to 500 μm and their use. Furthermore, publication WO 2021/009085 A1 discloses an air filter with a membrane layer made of silicon carbide.

### SUMMARY

It is the object of the invention to propose an air purifying device for purifying air, which has advantages over known air purifying devices, in particular a particularly high filter performance with low pressure loss.

This is achieved according to the invention with an air purifying device for purifying air. It is provided that the air filter has at least one filter body of a motor vehicle particle filter made of a ceramic material having a lipophilic surface.

The air purifying device serves to purify air, i.e. to at least partially remove foreign particles contained in the air. The air to be purified is sucked in by the air purifying device as raw air from an external environment of the air purifying device, purified or filtered and then expelled back into the outside environment as purified air. It goes without saying that the external environment of the air purifying device can be any air volume. In this respect, the external environment can be understood to mean, for example, an interior of a building, in particular a residential building, or the like. The foreign particles that are to be filtered out of the air using the air purifying device are, in particular, microorganisms. In the context of this description, microorganisms are understood to mean, in particular, bacteria, viruses and/or fungi.

The air purifying device is provided with the housing on which the air inlet and the air outlet are formed. The air inlet is provided as, for example, an air inlet opening or at least has one. The air inlet opening is formed in a wall of the housing, in particular on an outer wall of the housing. Analogously to this, the air outlet is provided as an air outlet opening or at least has one. The air outlet opening is also made in particular in the wall or outer wall of the housing. The air is sucked in as raw air through the air inlet and discharged as purified air through the air outlet. The air inlet and the air outlet are fluidly connected to one another via the flow path, wherein the flow path extends at least partially, preferably completely, in the housing. In particular, the air thus flows continuously in the housing from the air inlet to the air outlet.

The air conveying device and the air filter are present in the flow path or along the flow path. The fluid conveying device serves to convey air from the air inlet to the air outlet and accordingly along the flow path. The air conveying device is, for example, a fan, a blower or the like. The fluid conveying device can also have an ion wind generator. This serves to convey the air along the flow path and/or to (additionally) purify the air.

The ion wind generator is to be understood as meaning an air conveying device by means of which the air flow can be generated or is generated at least temporarily along the flow path. The ion wind generator basically has two electrodes, which are arranged at a distance from one another and by means of which an electric field is generated. For this purpose, a first electrical potential is applied to a first of the electrodes and a second electrical potential that is different from the first electrical potential is applied to a second electrode.

In addition to conveying the air, the ion wind generator purifies the air because the ions it produces effectively bind foreign particles. In particular, the ions ensure cluster formation of the foreign particles, i.e. aggregation of the foreign particles, whereupon the aggregated foreign particles can be separated particularly effectively from the air due to their higher weight. Additionally or alternatively, the ion wind generator generates ozone during its operation. This purifies and/or disinfects the air, wherein bacteria and/or viruses are killed or at least inactivated.

Furthermore, the air filter is arranged in the flow path. This serves to filter out foreign particles from the air. The air filter could be designed as a suspended matter filter and correspondingly have a filter element which is arranged in the flow path and through which the air flows at least temporarily. The filter element consists, for example, at least of fibers, in particular glass fibers, which filter out and store the foreign particles from the air through depth filtration. In such a design, the air filter can also be referred to as a HEPA filter.

However, such a filter element becomes clogged over time due to foreign particles aggregating in it, so it must be replaced from time to time. On the one hand, this is cost-intensive and, on the other hand, if microorganisms are present as foreign particles in the filter element, they can get out of the filter element while the filter element is being replaced, so that the microorganisms can spread. In addition, such a filter element is usually not reusable, so that there is a high use of resources and a large amount of waste is generated, which may even have to be disposed of separately due to the load with microorganisms.

For this reason, it is instead provided that the air filter has the filter body of the motor vehicle particle filter. This means that the filter body of the air filter is designed identically to the filter body of a motor vehicle particle filter or that the filter body is used either in the motor vehicle particle filter or in the air purifying device. In other words, the filter body is structurally identical to the filter body of the motor vehicle particle filter. The filter body consists of the ceramic material, for example at least partially or completely of one of the following materials: silicon carbide, cordierite and aluminum titanate.

The filter body or the ceramic material has a surface which is at least temporarily flowed against, over and/or flowed through by the air flowing along the flow path. This surface is also referred to as an air-conducting surface. The filter body is designed in such a way that its surface, in particular the air-conducting surface, is lipophilic. This has the advantage that moisture is removed from the foreign particles when they come into contact with the filter body. This leads to the inactivation of microorganisms, which generally require moisture or a moist environment.

The filter body can basically be of any design. The filter body is particularly preferably in the form of a wall-flooded filter body, in which the air flowing along the flow path flows through the filter body and thus the ceramic material. For this purpose, the ceramic material is porous. Overall, with the air purifying device described, a particularly good filtration performance is achieved with a low pressure loss due to the use of the filter body of the motor vehicle particle filter. In addition, the lipophilic surface of the filter body or the ceramic material serves to quickly deactivate the microorganisms that may be contained in the foreign particles. The use of the filter body described also enables its regeneration, so that there is no need to change the air filter or the filter element. Instead, an almost continuous operation of the air purifying device with the filter body is implemented.

A further development of the invention provides that the filter body has a plurality of flow channels fluidly arranged in parallel, each of which passes completely through the filter body, wherein each of the flow channels is closed by means of a closure. The filter body has an inlet side on the one hand and an outlet side on the other. For example, the filter body is cylindrical, in particular circular cylindrical, and the inlet side corresponds to a first end face of the filter body and the outlet side corresponds to a second end face of the filter body, the two end faces being arranged at a distance from one another, in particular at a parallel distance from one another. The two end faces are preferably connected to one another via a lateral surface of the filter body.

The filter body is penetrated by several flow channels, each of which fluidically connects the inlet side with the outlet side. This means that each of the flow channels runs from the inlet side to the outlet side. In particular, each of the flow channels passes through the first end face on the one hand and the second end face of the filter body on the other hand. The flow path extends through the filter body from its inlet side to its outlet side, namely through the flow channels. Preferably, the flow channels are not only arranged fluidly parallel to one another, but also have longitudinal center axes running parallel to one another. The flow channels particularly preferably run continuously straight, so that their longitudinal center axes are also continuously straight.

In order to create a wall-flooded filter body, each of the flow channels is fluidically closed by means of a closure. This means that the air flowing into a first of the flow channels can only flow up to the closure that closes this flow channel. In order to be able to flow further towards the outlet side, the air must first flow through the porous ceramic material in order to get from the first flow channel into a second flow channel. This allows it to continue to flow towards the outlet side. By allowing air to flow through the ceramic material, particularly effective purifying of the air is achieved.

The closure is to be understood in particular as a plug, which is inserted into the respective flow channel either on the inlet side or on the outlet side. The closure is designed in such a way that it fluidically closes the respective flow channel from the direction of the inlet side and in the direction of the outlet side. As a result, the air flowing into one of the flow channels is forced to flow through the ceramic material in order to reach another of the flow channels.

A further development of the invention provides that the flow channels include first flow channels and second flow channels, wherein the closures are arranged in the first flow channels at a first axial position with respect to a longitudinal center axis of the filter body and in the second flow channels at a second axial position different from the first axial position. In other words, the flow channels can be divided into the first flow channels and the second flow channels. The flow channels are preferably composed exclusively of the first flow channels and the second flow channels. Preferably, the first flow channels and the second flow channels are arranged alternately in one or more directions, so that respective two of the first flow channels accommodate one of the second flow channels between them and, conversely, respective two of the second flow channels accommodate one of the first flow channels between them. The first flow channels and the second flow channels differ with respect to the axial position at which the closure is arranged.

The closures are located in the first axial position in the first flow channels and in the second axial position in the second flow channels. The two axial positions are spaced apart from each other. In other words, the first axial position and the second axial position have different distances from the inlet side and the outlet side, respectively. For example, the first axial position is closer to the inlet side than the second axial position. Particularly preferably, the first axial position lies in the half of the filter body facing the inlet side and the second axial position lies in the half of the filter body facing the outlet side.

For example, the first axial position has a distance from the inlet side which corresponds to at most 30%, at most 20% or at most 10% of a total extension of the filter body in the axial direction. Conversely, the second axial position preferably has a distance from the outlet side which corresponds to at most 30%, at most 20% or at most 10% of the total extension of the filter body. This results in a particularly effective purifying of the air.

A further development of the invention provides that an air inlet grille is arranged in the air inlet, and/or that the air conveying device is fluidically arranged between the air filter and the air outlet, and/or that a pre-filter and/or a heating device are fluidically arranged between the air inlet and the air filter. In a first variant of the air purifying device, the air inlet grille is arranged in the air inlet. The air inlet grille is understood to mean the arrangement of several struts which partially close the air inlet and filter out coarse impurities from the air before they enter the air purifying device or the housing through the air inlet.

For example, the air inlet grille consists of multiple struts, which extend from a wall of the housing that delimits the air inlet in the radial direction outwards to a hub connecting the struts to one another. The hub has, for example, a projection which extends out of the air inlet in order to give the air inlet or the air purifying device the appearance of an aircraft engine.

In a second variant of the air purifying device, the air conveying device is arranged fluidically between the air filter and the air outlet. This means that it lies downstream of the air filter with respect to a main flow direction of the air, so that it sucks the air through the air filter and blows it towards the air outlet. This reliably prevents contamination of the air conveying device by foreign particles.

In a third variant of the air purifying device, the pre-filter or the heating device is arranged between the air inlet and the air filter. In other words, the pre-filter and/or the heating device are located upstream of the air filter or the filter body. If both the pre-filter and the heating device are implemented, the pre-filter is arranged upstream of the heating device. Accordingly, the heating device is fluidly located between the pre-filter and the air filter.

The pre-filter is used to filter out coarse foreign particles from the air before they reach the air filter and/or the heater. The pre-filter has, for example, a honeycomb structure. Additionally or alternatively, it has a different color than the housing of the air purifying device. The pre-filter is particularly preferably designed in the manner of a radiator inlet of a motor vehicle, so that the aircraft engine impression of the air purifying device is further enhanced.

The heating device is used to heat the air conveyed to the air filter. The heating device is preferably intended and designed to heat the air to a temperature which is sufficient to burn off or at least passivate foreign particles present in the air filter or the filter body and to regenerate the filter body accordingly.

Of course, it can be provided to combine one or more of the described variants of the air purifying device with one another. The air purifying device can thus have the air inlet grille in the air inlet, the air conveying device arranged between the air filter and the air outlet and the pre-filter and/or the heating device, preferably both the pre-filter and the heating device. This enables the air to be purified particularly effectively and sustainably.

A further development of the invention provides that a bypass channel is formed in the housing, which channel is arranged fluidically parallel to the air filter and fluidically in series with the air conveying device. In other words, the bypass channel is arranged in such a way that air conveyed by the air conveying device can be guided through the bypass channel around the air filter. If the bypass channel is closed, the air conveyed by the air conveying device flows (completely) through the air filter. If the bypass channel is partially or completely open, the air flows at least partially through the bypass channel and only partially through the air filter. This allows the air to be guided around the air filter, for example during regeneration of the air filter by the heater.

A further development of the invention provides that the air outlet is formed by a motor vehicle tailpipe. The motor vehicle tailpipe extends out of the housing. It is preferably contrasting in color and/or material compared to the housing. The motor vehicle tailpipe therefore has a different color and/or consists of a different material than the housing. The motor vehicle tailpipe is preferably cut at an angle, whereby it is longer at the top than at the bottom when the air purifying device is arranged as intended. Such a design of the air outlet serves to associate the air purifying device with a motor vehicle by a user, so that positive aspects of the air purifying device are also transferred to the motor vehicle.

A further development of the invention provides that the housing has a maintenance opening for removing the air filter, which is at least temporarily closed by means of a lid. Despite the long service life of the filter body, it may become necessary to replace it or regenerate it externally. To make this possible, the housing has the maintenance opening. This is arranged and dimensioned in such a way that the filter body can be removed from the housing through it or that it allows the filter body to be replaced. To prevent raw air from escaping from the housing, the maintenance opening is closed by the lid. In particular, the lid is always arranged to close the maintenance opening as long as the air purifying device is in operation and air is conveyed along the flow path by means of the air conveying device. The described embodiment of the air purifying device enables easy maintenance.

A further development of the invention provides that the lid is at least temporarily locked by means of a latch. The latch prevents unintentional and/or unauthorized opening of the maintenance opening. For example, the lid is locked as long as the air purifying device is in operation, i.e. air is being conveyed along the flow path by means of the air conveying device. Additionally or alternatively, the lid can be locked to prevent removal of a filter body loaded with foreign particles. The lid is released from the latch only after the filter body has been regenerated using the heating device, to open the maintenance opening. However, this preferably only occurs when a temperature of the filter body falls below or is lower than a threshold value.

The invention further relates to a method for operating an air purifying device for purifying air, in particular an air purifying device according to the present description, wherein the air purifying device has a housing on which an air inlet and an air outlet are formed, which are fluidically interconnected via a flow path extending in the housing, wherein an air conveying device for conveying the air along the flow path and an air filter for filtering out foreign particles from the air are arranged in the flow path. It is provided that the air filter has at least one filter body of a motor vehicle particle filter made of a ceramic material with a lipophilic surface.

The advantages of such a procedure and of such a design of the air purifying device have already been discussed. Both the air purifying device and the method for its operation can be developed further according to present description, to which reference will therefore be made.

A further development of the invention provides that the filter body is regenerated at least temporarily by operating a heating device arranged in the flow path upstream of the filter body, in order to heat the air supplied to the filter body. During operation of the air purifying device, the foreign particles from the air collect in the filter body and accumulate there. In order to avoid clogging of the filter body and to continue to achieve high filtration performance with a low pressure loss, the filter body is regenerated from time to time.

Regeneration involves heating the air supplied to the filter body using the heating device. In particular, the air is heated during regeneration in such a way that the foreign particles present in the filter body are oxidized or burned. A comparatively high temperature is necessary for this.

If the air purifying device only serves to filter out microorganisms from the air, it is sufficient to simply heat the air to a lower temperature, for example to at least 50° C., at least 60° C. or at least 70° C. However, the air is preferably heated to at least 100° C., at least 125° C. or at least 150° C. The heating of the air supplied to the filter body is carried out over a certain period of time, for example over at least 3 minutes, at least 5 minutes or at least 20 minutes. Additionally or alternatively, it is provided to heat the air until a pressure difference across the filter body falls below a threshold value.

Additionally or alternatively, in the course of the regeneration, it can be provided to remove the filter body from the housing and to heat it in an external device, in particular to a temperature at which the foreign particles present in the filter body oxidize or burn. The external device is, for example, an oven or something similar. The regeneration of the filter body enables the continuous provision of high quality air.

A further development of the invention provides that at least at a temperature of the filter body that deviates from an ambient temperature, a temperature of the air present downstream of the filter body is set to a target temperature by at least partially releasing a bypass channel arranged fluidically in parallel to the air filter. The bypass channel allows the air to flow around the filter body.

Since the filter body and the air flowing through it have a high temperature during regeneration, which is higher than ambient temperature, it is necessary to cool the air present downstream of the filter body in order to bring it to an acceptable level before it exits the air purifying device.

For this purpose, the bypass channel is at least partially opened, so that part of the air conveyed by the air filter device flows through the bypass channel and only part of the air flows through the filter body. The air flowing through the filter body and the air flowing through the bypass channel are brought together again downstream of the filter body, so that the air that has flowed through the filter body is cooled. The air is then discharged from the air purifying device through the air outlet. The procedure described enables reliable regeneration of the filter body without impairing the comfort of a user.

A further development of the invention provides that the regeneration of the filter body is carried out when a pressure difference across the filter body measured by at least one pressure sensor exceeds a threshold value. The pressure difference indicates how many foreign particles are absorbed in the filter body. The higher the pressure difference, the greater the amount of foreign particles. If the pressure difference exceeds the threshold value, it is concluded that regeneration of the filter body is necessary. The regeneration of the filter body is initiated accordingly. This ensures long-term, reliable operation of the air purifying device.

A further development of the invention provides that a lid closing a maintenance opening is locked after a certain operating time has elapsed after commissioning or after the last regeneration has been carried out, and/or that the lid is kept locked until the filter body has been regenerated. The described procedure serves to prevent a filter body loaded with foreign particles from being removed from the housing. Accordingly, the lid is locked at the latest after a certain operating time of the air purifying device has expired. Additionally or alternatively, it is provided to lock the lid as soon as the pressure difference across the filter body exceeds or is greater than a (further) threshold value. Additionally or alternatively, the lid is only unlocked again when the filter body has been regenerated. This ensures that the filter body removed from the housing is micro biologically harmless.

The features and feature combinations described in the description, in particular the features and feature combinations described below in the description of the figures and/or shown in the FIGURES may be used not only in the respective combination specified, but also in other combinations or alone, without departing from the scope of the invention. The invention should therefore also be considered to comprise embodiments that are explicitly not shown or explained in the description and/or the FIGURES, but emerge from the explained embodiments or can be derived from them.

### BRIEF DESCRIPTION OF THE FIGURES

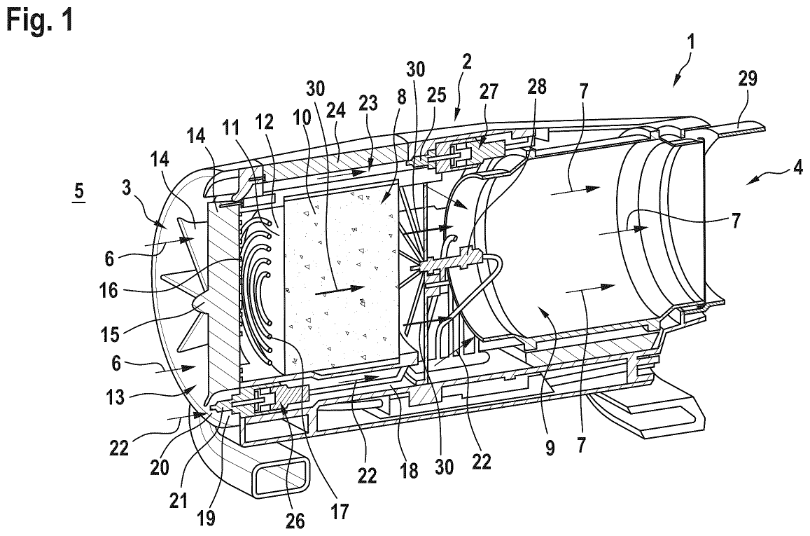

In the following, the invention will be explained in greater detail with reference to the exemplary embodiments depicted in the drawings, without this restricting the invention. In particular, the only FIG. 1 shows a schematic sectional view of an air purifying device.

### DETAILED DESCRIPTION

FIG. 1 shows a schematic sectional view of an air purifying device 1, which is used to purify air. The air purifying device 1 has a housing 2 on which an air inlet 3 and an air outlet 4 are formed. During operation of the air purifying device 1, air from an external environment 5 is sucked into the air purifying device 1 as raw air through the air inlet 3 and released back into the external environment 5 as purified air through the air outlet 4. This is indicated by arrows 6 and 7.

The air inlet 3 and the air outlet 4 are fluidly connected to one another via a flow path running in the housing 2. There is an air filter 8 and an air conveying device 9 along the flow path, the latter of which is only indicated very schematically. The air filter 8 is—based on a main flow direction of the air flowing through the air purifying device 1—arranged upstream of the air conveying device 9. It has a filter body 10, which consists of a ceramic material with a lipophilic surface. The filter body 10 is designed as a filter body of a motor vehicle particle filter or is constructed analogously to one. In this respect, there are several flow channels 11 and 12 arranged in parallel in the filter body, which are only indicated here.

The entire filter body 10 is preferably interspersed with such flow channels 11 and 12, wherein each of the flow channels 11 and 12 completely passes through the filter body 10 in the main flow direction of the air. In particular, there are multiple flow channels 11 and multiple flow channels 12, wherein the flow channels 11 can also be referred to as first flow channels 11 and the flow channels 12 can also be referred to as second flow channels 12. The flow channels 11 and 12 are each closed by means of a closure, which can be designed as a plug. The closures of the flow channels 11 and 12 are arranged at different axial positions, namely in such a way that the filter body 10 is designed as a wall-flooded filter body 10.

It can be seen that in the air inlet 3 there is an air inlet grille 13, which is composed of several struts 14 which are arranged in a star shape and meet at a central hub 15 or are fastened to one another via this hub. Furthermore, it can be seen that a pre-filter 16 and a heating device 17 are fluidically arranged between the air inlet 3 and the air filter 8. In the exemplary embodiment shown here, the heating device 17 is provided as a heating coil, which largely overlaps an end face of the filter body 10, in particular by at least 50%, at least 60% or at least 70%.

A bypass channel 18 is also formed in the housing 2, which on the one hand opens into an annular chamber 19, which is formed in the housing 2 and at least partially but preferably continuously surrounds the air inlet 3 in the circumferential direction. The annular chamber 19 opens into the external environment 5 via a mouth opening 20. With the aid of a valve element 21, which is arranged in the annular chamber 19, a flow cross section of the mouth opening 20 can be adjusted. In a first setting, the mouth opening 20 is preferably completely closed and at least partially opened in a second position. In the first setting, the bypass channel 18 is fluidically closed and is at least partially opened in the second setting. The flow that occurs in the second setting is indicated by arrows 22. The bypass channel 18 is arranged in such a way that it is fluidically arranged in series with the air conveying device 9, but fluidically in parallel relative to the filter body 10. Air flowing through the bypass channel 18 is guided around the air filter 8.

Furthermore, the air purifying device 1 has a maintenance opening 23 formed in the housing 2, which is closed at least temporarily by means of a lid 24. The maintenance opening 23 allows the air filter 8 to be removed or replaced. The lid 24 is at least temporarily locked by means of a latch 25. The valve element 21 is preferably adjustable or displaceable by means of a first magnetic actuator 26 and the latch 25 by means of a second magnetic actuator 27.

Finally, the air purifying device 1 has a pressure sensor 28, by means of which the differential pressure across the air filter 8 can be measured. The pressure sensor 28 is preferably arranged downstream of the air filter 8 centrally in the flow path in order to implement a reliable and accurate pressure measurement. Furthermore, it should be noted that the air outlet 4 is formed by a motor vehicle tailpipe 29 or is visually based on one.

The air purifying device 1 described enables the air to be reliably purified or foreign particles to be reliably filtered out of the air. Since these foreign particles can include microorganisms, it is intended to regenerate the air filter 8 from time to time. For this purpose, the air supplied to the air filter 8 is heated by means of the heating device 17, namely to a temperature which at least ensures that the microorganisms are inactivated. The warm air flows through the air filter 8 according to the arrows 30. It is merged downstream of the air filter 8 with air which has been guided around the air filter 8 through the bypass channel 18 in order to set the air flowing out of the air outlet 4 into the outside environment 5 at a pleasant temperature.

Of course, the air filter device 1 described is not limited to the embodiment shown here. Rather, it can be provided that the air purifying device 1 is integrated into an air-conditioning system, for example into a ventilation system of a building or residential building. In any case, the particularly good filter performance of the filter body 10 of the motor vehicle particle filter can be exploited in order to achieve particularly thorough purifying of the air.

The filter body 10 is preferably designed in such a way that it has a filter efficiency of at least 95% for particles up to a diameter of 5 nm. Typical viruses that are to be filtered out of the air using the air purifying device 1 have a diameter of 60 to 140 nm. For such particles, the air filter 8 has a filter efficiency or a separation rate of at least 90%, at least 92% or at least 94%.

### LIST OF REFERENCE NUMERALS

1 air purifying device
2 housing
3 air inlet
4 air outlet
5 outer environment
6 arrow
7 arrow
8 air filter
9 air conveying device
10 filter body
11 flow channel
12 flow channel
13 air intake grille
14 strut
15 hub
16 pre-filter
17 heating device
18 bypass channel
19 annular chamber
20 mouth opening
21 valve element
22 arrow
23 maintenance opening
24 lid
25 latch
26 1st magnetic actuator
27 2nd magnetic actuator
28 pressure sensor
29 motor vehicle tailpipe
30 arrow

1-10. (canceled)

11. An air purifying device for purifying air, comprising a housing, on which an air inlet and an air outlet are formed, which are fluidically interconnected via a flow path extending in the housing, wherein an air conveying device for conveying the air along the flow path and an air filter for filtering foreign particles out of the air are disposed in the flow path, wherein the air filter has at least one filter body of a motor vehicle particle filter made of a ceramic material having a lipophilic surface.

12. The air purifying device according to claim 11, wherein the filter body has multiple flow channels fluidically arranged in parallel, which respectively pass completely through the filter body, wherein each of the flow channels is closed by means of a closure.

13. The air purifying device according to claim 11, wherein the flow channels comprise first flow channels and second flow channels, wherein the closures in the first flow channels are arranged at a first axial position with respect to a longitudinal center axis of the filter body and in the second flow channels are arranged at a second axial position different from the first axial position.

14. The air purifying device according to claim 11, wherein an air inlet grille is arranged in the air inlet, and/or that the air conveying device is fluidly arranged between the air filter and the air outlet, and/or that in terms of flow technology there is a pre-filter and/or a heating device between the air inlet and the air filter.

15. The air purifying device according to claim 11, wherein a bypass channel is formed in the housing, which channel is arranged fluidically in parallel to the air filter and fluidically in series with the air conveying device.

16. The air purifying device according to claim 11, wherein the housing has a maintenance opening for removing the air filter, which is at least temporarily closed by means of a lid.

17. A method for operating an air purifying device for purifying air, in particular an air purifying device according to one or more of the preceding claims, wherein the air purifying device has a housing on which an air inlet and an air outlet are formed, which are fluidly interconnected via a flow path extending in the housing, wherein an air conveying device for conveying the air along the flow path and an air filter for filtering foreign particles out of the air are arranged in the flow path, wherein the air filter has at least one filter body of a motor vehicle particle filter made of a ceramic material having a lipophilic surface.

18. The method according to claim 17, wherein a regeneration of the filter body is carried out at least temporarily by operating a heating device arranged in the flow path upstream of the filter body, to heat the air supplied to the filter body.

19. The method according to claim 17, wherein at least at a temperature of the filter body that deviates from an ambient temperature, a temperature of the air present downstream of the filter body is set to a target temperature, by at least partially releasing a bypass channel fluidically arranged in parallel to the air filter.

20. The method according claim 17, wherein the regeneration of the filter body is carried out when a pressure difference across the filter body measured by at least one pressure sensor exceeds a threshold value.

21. The air purifying device according to claim 12, wherein the flow channels comprise first flow channels and second flow channels, wherein the closures in the first flow channels are arranged at a first axial position with respect to a longitudinal center axis of the filter body and in the second flow channels are arranged at a second axial position different from the first axial position.

22. The air purifying device according to claim 12, wherein an air inlet grille is arranged in the air inlet, and/or that the air conveying device is fluidly arranged between the air filter and the air outlet, and/or that in terms of flow technology there is a pre-filter and/or a heating device between the air inlet and the air filter.

23. The air purifying device according to claim 13, wherein an air inlet grille is arranged in the air inlet, and/or that the air conveying device is fluidly arranged between the air filter and the air outlet, and/or that in terms of flow technology there is a pre-filter and/or a heating device between the air inlet and the air filter.

24. The air purifying device according to claim 12, wherein a bypass channel is formed in the housing, which channel is arranged fluidically in parallel to the air filter and fluidically in series with the air conveying device.

25. The air purifying device according to claim 13, wherein a bypass channel is formed in the housing, which channel is arranged fluidically in parallel to the air filter and fluidically in series with the air conveying device.

26. The air purifying device according to claim 14, wherein a bypass channel is formed in the housing, which channel is arranged fluidically in parallel to the air filter and fluidically in series with the air conveying device.

27. The air purifying device according to claim 12, wherein the housing has a maintenance opening for removing the air filter, which is at least temporarily closed by means of a lid.

28. The air purifying device according to claim 13, wherein the housing has a maintenance opening for removing the air filter, which is at least temporarily closed by means of a lid.

29. The air purifying device according to claim 14, wherein the housing has a maintenance opening for removing the air filter, which is at least temporarily closed by means of a lid.

30. The air purifying device according to claim 15, wherein the housing has a maintenance opening for removing the air filter, which is at least temporarily closed by means of a lid.
